(19) United States
(12) Patent Application Publication
(10) Pub. No.: US 2014/0011154 A1
(43) Pub. Date: Jan. 9, 2014

(54) Bracket Intended to Form Part of an Orthodontic Brace and Method of Fabricating Same

(71) Applicant: H32, Paris (FR)

(72) Inventors: Patrick Curiel, Neuilly Sur Seine (FR); Philippe Salah, Paris (FR); William Ayache, Neuilly Sur Seine (FR)

(21) Appl. No.: 13/997,563

(22) PCT Filed: Dec. 27, 2011
(86) PCT No.: PCT/EP2011/074110

§ 371 Date: Sep. 3, 2013

(30) Foreign Application Priority Data
Dec. 28, 2010 (FR) 1061310

(51) Int. Cl. A61C 7/14

(52) U.S. Cl. CPC A61C 7/14; A61C 7/145
USPC 433/10; 433/8; 29/896.11

(57) ABSTRACT

The invention relates to a method for producing an attachment intended to form part of an orthodontic appliance and comprising a recess for receiving an orthodontic arch. During a first step, an attachment blank is produced, comprising an attachment portion of standardized configuration and dimensions and a base portion. During a second step, the base portion is shaped in order to provide the attachment with a customized configuration developed in accordance with the configuration of the tooth on which the attachment is to be placed and the desired position of the recess after the attachment has been secured to the tooth. Once it has been manufactured, the attachment has an attachment portion and a base. The invention also relates to the resulting attachment blank and attachment and to an orthodontic appliance including said attachment.

The invention concerns a bracket intended for an individualized orthodontic brace for the treatment of a patient, intended mainly, but not exclusively, to be used in a lingual technique, i.e. with the brace disposed on the non-visible posterior face of the teeth.

Such braces conventionally include:
at least one orthodontic wire, in other words a metal wire exerting on the teeth a force tending to move them from their initial unsatisfactory position, called the “wrong position”, to a final satisfactory position, called the “corrected position”; and
a series of brackets each provided with at least one groove for receiving an orthodontic wire.

The brackets are fixed individually to the teeth of the patient, in a particular position enabling the orthodontic wire to transfer to the teeth the forces necessary for them to move from the wrong position to the corrected position during treatment. This fixing is performed by means of a “base”, i.e. an intermediate member one face of which espouses the surface of the tooth to which the bracket must be fixed and the other face of which supports the bracket.

One or more orthodontic wires are usually used, with a single series of brackets each including one or more grooves.

Lingual orthodontic techniques, which have the aesthetic advantage of leaving the brace practically invisible from the outside, began to be developed around 1980. In their case, an important element in the success of the treatment is the correct positioning of the bracket and its groove on the tooth, since this position determines the orientation of the forces that are imposed on the corresponding tooth and thus the orientations of the tooth in various directions in space when in its final, corrected position. This positioning is much more difficult in the lingual technique than in the labial or vestibular technique (in which the brace is disposed on the anterior face of the teeth), because of the high angulation of the posterior faces of the teeth. This angulation means that a slight error in the positioning of the bracket can place the groove in a bad position, where it is incapable of ensuring the required correction of the position of the tooth.

Information technology techniques have brought major improvements to the ease of designing individualized orthodontic braces specific to each patient.

In particular, the document WO-A-03/068099 teaches individually designing an assembly formed on the one hand by a virtual image of a base for fixing to the tooth, designed digitally from a computer image of the dental arch of the patient with the teeth in the wrong position, and on the other hand a virtual image of a bracket provided with a groove for inserting the orthodontic wire, this image being taken from a virtual library of brackets of predetermined shapes. A bracket formed of a unique body resulting from the combination of these two images is then formed by fast prototyping. An orthodontic wire intended to link the brackets and to bring the teeth of the patient to the corrected position is then designed and shaped by means of a special device.

However, the body forming both the base fixed to the tooth and the bracket carrying the groove for inserting the wire being designed and fabricated by fast prototyping, it is difficult to produce bracket systems in which the shape of the brackets is improved. In particular, it may be difficult to use brackets which integrate a system for immobilizing the wire by clipping or other brackets known as “self-ligating brackets”. This type of bracket, used more and more, would appear an important element for the complete success of the treatment.

An alternative solution to the above technique consists in designing the brace by a computerized method but integrating into the design of the units formed by the brackets and the bases pre-existing (“mass-produced”) brackets with standardized shapes and dimensions, mass-produced by machining blocks of metal or injection moulding metal powder (this technique is known as metal injection moulding (MIM)). Obtaining devices precisely adapted tooth by tooth to the morphology of the patient with a view to correcting the wrong position is thus effected entirely by way of the bases, once the models and the dimensions of the brackets have been chosen by the practitioner, as a function of the particular needs of the patient. Each base is then produced with the shape and dimensions determined by the design software for the orthodontic brace and is placed on the corresponding tooth. The bracket is then positioned on the base and is fastened to it, for example by welding or any other firm fixing means. Finally, the base+bracket assembly is fixed to the tooth by using an adhesive to glue it on.

A disadvantage of this technique is that welding the bracket to the base is time-consuming and meticulous work for the technician carrying it out and does not guarantee the accuracy of the positioning of the bracket. There is also a risk of separation of the bracket and the base because of the stresses exerted by occlusal forces if the weld is not carried out correctly. Thus the highly accurate dimensions of the brace design achieved by the computer means are not fully exploited in the brace actually produced, despite the fact that the brackets are produced by machining or MIM, and thus with high dimensional accuracy.

The aim of the invention is to propose a method of designing and producing elements of an orthodontic brace and a resulting brace that optimally reconcile imperatives relating to:
the dimensional accuracy of the elements fastened to the teeth of the patient;
the dimensional stability and reliability of those same elements; and
the economic production of these same elements.

To this end, the invention provides a method of fabricating a bracket intended to form part of an orthodontic brace and including a housing for receiving an orthodontic wire, characterized in that, in a first stage, a bracket blank is produced including a bracket portion with a standardized configuration and standardized dimensions and a base portion, and in that, in a second stage, the base portion is shaped to confer on the bracket a configuration individualized as a function of the configuration of the tooth on which the bracket is to be placed and the required position of the housing after fixing the bracket to the tooth, the bracket having at the end of its fabrication process a bracket portion and a base.

The bracket portion and the base portion of the bracket blank may be produced in one piece.

The bracket portion and the base portion may be produced separately and then joined together.

A site for receiving the bracket portion may be formed on the base portion.

In this case, the bracket portion and the base portion may be joined by automatic mass-production welding.

The base portion may also have a standardized configuration and standardized dimensions after the first stage.

At least one of the portions of said blank may be produced by machining or laser cutting.

At least one of the portions of said blank may be produced by injection moulding metal powder.

The invention also provides a bracket blank for orthodontic braces, including a bracket portion provided with a housing for an orthodontic wire, the bracket portion being shaped to confer on it the shape of an orthodontic brace bracket with a standardized configuration and standardized dimensions and a base portion consisting of an excrescence attached to the bracket portion.

The base portion may also have a standardized configuration and standardized dimensions.

The invention also provides a bracket intended to form part of an orthodontic brace, characterized in that it includes a bracket portion with a standardized configuration and standardized dimensions and a base portion and in that it is produced by shaping a bracket blank of the previous type.

The bracket may be intended for a lingual brace.

The bracket may be intended for a vestibular brace.

It may be a self-ligating bracket.

The invention further provides an orthodontic brace including an orthodontic wire and brackets provided with a housing for receiving the orthodontic wire, characterized in that at least one of said brackets is of the previous type.

As will have been understood, the invention relies particularly on the use of brackets fabricated by methods such as machining, laser cutting or MIM, or techniques derived from them, and thus methods guaranteeing the best possible dimensional accuracy and allowing complex shapes to be produced such as those of self-ligating brackets.

These brackets are fabricated in two stages. In the first stage a blank of the bracket is first produced, for example by a machining, laser cutting or MIM process. On this blank, the functional part of the bracket, i.e. that which is intended to receive and to retain the orthodontic wire, is completely finished, having a standardized configuration and standardized dimensions. The remainder of the blank is an excrescence that may also be of standardized configuration and size, although this is not mandatory. The bracket is shipped in this form to the technician responsible for manufacturing the elements of the brace and it is by shaping the excrescence, notably by a machining or laser cutting process, that the second stage produces the base that will allow fixing of the bracket to the tooth for which it is intended and will impart to the functional part of the bracket its required accurate position.

In a first embodiment, the blank is produced in one piece. In a second embodiment, the bracket part of the blank and the excrescence are produced separately and then joined together reliably, for example by automatic mass-production laser or other welding.

The configuration that this base must acquire during the second stage has been determined beforehand in the conventional manner by the computer tools available to the technician, these tools having integrated from the outset the fact that the bracket must have the chosen configuration. The same computer tools allow optimum control of the shaping of the excrescence allowing its required final configuration to be conferred on the one-piece bracket+base assembly.

The invention will be better understood after reading the following description, given with reference to the appended drawings, in which:

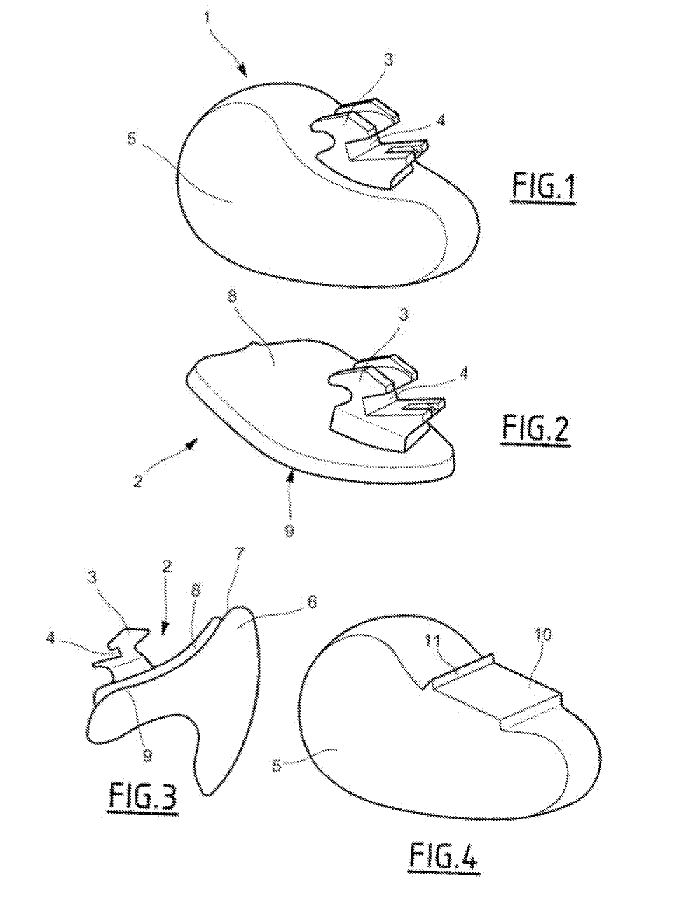

FIG. 1 shows diagrammatically one example of a bracket blank of the invention, with the excrescence that it includes after its fabrication and before its final shaping;

FIG. 2 shows the bracket after shaping the excrescence to confer on it the shape of a base adapted to espouse the face of the tooth to which the bracket must be fixed;

FIG. 3 shows diagrammatically the bracket of the invention after shaping its excrescence, installed on the tooth for which it was intended; and

FIG. 4 shows a variant of the base portion provided with a site for receiving the bracket portion.

FIG. 1 represents the bracket blank after the first step of fabrication of the bracket 2 of the invention. This blank 1 has typically been produced by a machining or an MIM process and has two portions. The manufacturer of the blank may chose to produce these two portions in one piece, from a single metal block, or as two initially separate parts, thereafter joined by a reliable method such as automatic mass-production laser or other welding. In the latter case, the reliability of the weld between the two portions of the bracket is much higher than that obtained by the usual methods between a bracket and a base that are both conventional.

The first portion 3, referred to as the “bracket portion”, has a standard bracket configuration, notably with a housing 4 to receive the orthodontic wire. It must be understood that this configuration may conform to that of any known type of bracket. The example represented diagrammatically in the figures is in no way limiting on the invention. In particular, and in the usual way, the bracket portion 3 may be either of a type in which the wire is subsequently retained in the housing 4, in the conventional way, by inserting in the bracket portion 3 a metal or elastomer ligature, or of a self-ligating type in which the wire is retained by adding to the bracket a piece that can be moved by the practitioner between a position leaving the housing 4 open to allow insertion of the wire and a closed position obstructing the housing 4 after inserting the wire. The example of a bracket represented is intended for a lingual brace, intended to be positioned on the internal face of the dental arch of the patient, but the invention is also applicable to the brackets of vestibular braces.

The second portion 5, referred to as the “base portion”, is an excrescence on the bracket portion 3. It may be of any general shape, for example broadly spherical or broadly parallelepipedal (as represented in FIG. 1), what is essential being that it includes sufficient material for the base of the bracket 2 to be machined therein in the second stage of fabricating the bracket 2.

FIG. 2 diagrammatically represents the bracket 2 of the invention in its definitive configuration, after shaping the base portion 5. This shaping is carried out so as to configure the base portion 5 as a standard type base to which the bracket is intended to be fixed, the assembly forming the bracket 2 having the configuration that the design software of the brace has predetermined as a function of the precise requirements of the patient in respect of the tooth 6 to which the bracket 2 is to be fixed. This configuration was supplied in digital form to the device that performed the shaping, which may in particular be effected by a machining or laser cutting process.

FIG. 3 represents the bracket 2 fixed in a manner known in the art by means of an adhesive to the tooth 6 for which it was intended. As stated, in this example, the bracket 2 is placed on the posterior face 7 of the tooth 6 because the brace including the bracket 2 is of the lingual type. This type of brace constitutes the preferred application of the invention because it necessitates the bases 8 supporting the bracket portions 3 to have extremely precise configurations so that their lower face 9 perfectly espouses the posterior face 7 of the tooth and so that the housings 4 of the brackets 2 are placed exactly at the locations that will allow the orthodontic wire to move the teeth 5 accurately to the target positions after treatment. The assemblies formed by the bases plus the bracket portions must therefore have individualized configurations for each tooth of each patient. The invention allows the precise required configuration to be obtained for each of these assemblies, in particular because it provides for the bracket portion 3 and the base 8 to be produced in one piece or joined together by a reliable standardized method instead of being individually welded. The base 8 and the bracket portion 3 also cannot be separated from each other, or can only be so with much greater difficulty than in the prior art, and this guarantees the solidity of the bracket 2 during the use of the brace.

This method of fabricating the bracket 2 has the advantage of achieving an excellent compromise between imperatives linked to design and manufacture at moderate cost of brackets 2 of high mechanical and dimensional quality. The manufacturer of the bracket blanks 1 may produce these blanks in a standardized manner, and thus quickly, using an MIM, machining or laser cutting process and conferring on the bracket portions 3 the usual shapes and dimensions of mass-produced brackets of known types. It is only at the second stage of fabrication (shaping the base portion 5 of the blank 1 to obtain the base 8) that the technician, who then knows the precise configuration of the bracket to be obtained, proceeds to individualize each bracket. This considerably reduces their working time, and therefore the cost of the brace, because:
it only remains for the technician to shape the base portion 5 individually, the bracket portion 3, the production of which is more complex, already having been mass-produced during the fabrication of the blank 1;
the bracket portion 3 and the base 8 being two portions of the same part or two parts already welded by a reliable and standardized method, they are not fastened together at this stage; as already stated, this construction imparts high functional reliability to the bracket 2, limiting or eliminating the risk of having to be worked on subsequently to restore the functionality of the brace, with all the drawbacks for the patient linked to such intervention.

Most of all, the construction of the bracket+base assembly as described guarantees excellent accuracy of configuration and dimensions for the assembly as a whole. The bracket+base assembly is thus produced exactly as calculated by the computer means during the design of the orthodontic brace.

With regard to the materials in which the bracket 2 of the invention may be produced, these are simply a ceramic or the metals or other materials usually employed for the fabrication of machined mass-produced brackets, such as stainless steel or titanium, able to be shaped by high-accuracy methods such as machining, laser cutting or MIM.

Of course, it is possible to produce the two portions 3, 5 of the blank by the same method (machining, laser cutting, MIM, etc.) or to produce each portion by a different method.

If the bracket portion 3 and the base portion 5 are initially separate parts, it is preferable, although not obligatory, to produce on the base portion 5 a site to receive the bracket portion 3, for example in the form of a recess or a relief ensuring predetermined positioning of the bracket portion 3 on the base portion 5. This contributes to the reliability of the assembly and standardizes the control of the machining of the base portion 5. In this case, it is preferable for the base portion 5, or at least the site to receive the bracket portion 3, to be shaped in a highly accurate and standardized manner. FIG. 4 shows diagrammatically one example of a base portion 5 where the reception site is materially represented by a promontory 10 provided with an abutment 11. This form of reception site is only a nonlimiting example, of course.

It goes without saying that although the invention finds a preferred application to brackets used in lingual orthodontics, it is entirely applicable to brackets intended to be used in vestibular orthodontics.

The brackets fabricated in accordance with the invention may preferably be integrated into an orthodontic brace of which all the brackets are designed and fabricated in this way. However, at the choice of the practitioner, such brackets may be used on only some teeth of the patient, and brackets of another type used on the other teeth.

1. A method of fabricating a bracket intended to form part of an orthodontic brace and including a housing for receiving an orthodontic wire, the method comprising:
in a first stage, a bracket blank is produced including a bracket portion with a standardized configuration and standardized dimensions and a base portion; and
in a second stage, the base portion is shaped to confer on the bracket a configuration individualized as a function of the configuration of the tooth on which the bracket is to be placed and the required position of the housing after fixing the bracket to the tooth, the bracket having at the end of its fabrication process a bracket portion and a base.

2. The method as claimed in claim 1, wherein the bracket portion and the base portion of the bracket blank are produced in one piece.

3. The method as claimed in claim 1, wherein the bracket portion and the base portion are produced separately and then joined together.

4. The method as claimed in claim 3, wherein a site for receiving the bracket portion is formed on the base portion.

5. The method as claimed in claim 4, wherein the bracket portion and the base portion are joined by automatic mass-production welding.

6. The method as claimed in claim 1, wherein the base portion also has a standardized configuration and standardized dimensions after the first stage.

7. The method as claimed in claim 1, wherein at least one of the portions of said blank is produced by machining or laser cutting.

8. The method as claimed in claim 1, wherein at least one of the portions of said blank is produced by injection moulding metal powder.

9. A bracket blank for orthodontic braces, including a bracket portion provided with a housing for an orthodontic wire, the bracket portion being shaped to confer on it the shape of an orthodontic brace bracket with a standardized configuration and standardized dimensions and a base portion consisting of an excrescence attached to the bracket portion.

10. The bracket blank as claimed in claim 9, wherein the base portion also has a standardized configuration and standardized dimensions.

11-15. (canceled)

16. A bracket intended to form part of an orthodontic brace, the bracket comprising:
a bracket portion with a standardized configuration and standardized dimensions; and
a base portion; wherein the bracket portion and the base portion are produced by shaping a bracket blank;
in a first stage to produce the bracket portion with the standard configuration and standardized dimensions; and
in a second stage to produce the base portion to individualize the base portion to the configuration of a tooth to which the base potion is to be placed.

17. The bracket of claim 16 wherein the orthodontic brace is in a lingual brace.

18. The bracket of claim 16 wherein the orthodontic brace is a vestibular brace.

19. The bracket of claim 16 wherein the bracket is a self-ligating bracket.
